(19) United States
(12) Patent Application Publication
(10) Pub. No.: US 2017/0337577 A1
(43) Pub. Date: Nov. 23, 2017

(54) SYSTEMS AND METHODS ASSOCIATED WITH ADAPTIVE REPRESENTATION OF A PRICE/SPEND RELATIONSHIP

(71) Applicant: AOL Advertising Inc., Dulles, VA (US)

(72) Inventor: Niklas Karlsson, Mountain View, CA (US)

(21) Appl. No.: 15/160,226

(22) Filed: May 20, 2016

(51) Int. Cl. G06Q 30/02

(52) U.S. Cl. CPC G06Q 30/0246; G06Q 30/0204

(57) ABSTRACT

Embodiments of the present invention provide systems, methods, and computer storage media directed at adaptive representation of a price/spend relationship. In embodiments, a method may include receiving, from a campaign control system, a request for price/spend relationship information of a target event for a target audience. In response, a representation of a price/spend curve can be generated. The representation of the price/spend curve can include a number of price segments. In embodiments, the price segments included within the representation of the price/spend curve are determined based, at least in part, on a spend uncertainty threshold allowed within each price segment. The resulting representation of the price spend curve can then be transmitted to a control system. Other embodiments may be described and/or claimed herein.

### TECHNICAL FIELD

The present disclosure relates generally to computing. More specifically, and without limitation, the present disclosure relates to systems and methods for adaptive representation of a price/spend relationship.

### BACKGROUND

Some online content providers are interested in placing content on websites (e.g., to promote products or services). In such a context, the placing of the content can also be referred to as an “impression” of the content. In general, these online content providers pay based on events, for example, impressions, clicks, views, or conversions over the course of a content campaign in an effort to achieve a desired revenue for the content campaign. In a campaign, revenue generally refers to the amount of money actually spent or the number of events delivered. As a result, estimating a relationship between a price and an estimated spend amount at that price is important to properly manage the campaign, e.g., to try and achieve desired revenue.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### BRIEF DESCRIPTION OF THE DRAWINGS

FIG. 1 depicts an illustrative content delivery system, in accordance with embodiments of the present disclosure.

FIG. 2 depicts an illustrative online control system for controlling an online content delivery campaign operating in an online content network, in accordance with various embodiments of the present disclosure.

FIG. 3 depicts an illustrative control system, in accordance with various embodiments of the present disclosure.

FIG. 4 depicts illustrative pseudo code that can be utilized for producing a vector representation of a price/spend (P/S) curve, in accordance with various embodiments of the present disclosure.

FIG. 5 depicts pseudo code for an illustrative function that can produce a representation of a P/S curve, in accordance with various embodiments of the present disclosure.

FIG. 6 depicts an illustrative process flow for processing a request for a vector representation of a P/S curve, in accordance with various embodiments of the present disclosure.

FIG. 7 depicts an illustrative process flow for generating an adaptive representation of a P/S curve, in accordance with various embodiments of the present disclosure.

FIG. 8 is a graphical depiction of a partitioning procedure with respect to P/S information to form a representation of a P/S curve, in accordance with various embodiments of the present disclosure.

FIGS. 9-12 depict example P/S curves and corresponding P/S curve representations, in accordance with various embodiments of the present disclosure.

FIG. 13 is a block diagram of an example computing device in which various embodiments of the present disclosure may be employed.

### DETAILED DESCRIPTION OF THE EMBODIMENTS

A relationship between a price and an estimated spend amount can take the form of a price/spend (P/S) curve that correlates prices with corresponding estimated resulting spend at each price. One mechanism for providing such a P/S curve is to equally divide the range of prices into increments (e.g., into $0.01 price increments) and to determine an estimated spend corresponding with each increment. Such a mechanism, however, does not take into account that certain prices segments within the price range yield higher magnitude spend changes than other price segments within the price range, which may yield little to no change in magnitude with respect to spend. As a result, a great deal of processing time can be wasted calculating estimated spend for price increments without regard to the change in volume that the price increment yields. In addition, such a mechanism can provide a large quantity of data. For example, if the price range spans from $0.00 to $10.00, then the resulting data, at $0.01 increments, would include a total of 1,000 points of price data and another 1,000 points of corresponding spend data. As such, in addition to the processing considerations above, a great deal of bandwidth can be taken up in transmitting this quantity of data. Because of these considerations, the above mechanism does not scale well as more and more requests for P/S information are received and processed.

In embodiments of the present disclosure, methods and systems associated with representations of P/S curves are described. Such representations can include price segments selected based, at least in part, on a difference in magnitude in estimated spend that is represented by the price segment (i.e., occurs across the price segment). Furthermore, prices that fall within the price segments need not be analyzed, saving a great deal of computational resources. In addition a great deal of bandwidth savings can also be realized by only transmitting the data for those price segments that are included within the vector representation of the P/S curve. It will also be appreciated that each price segment can be processed independently thereby enabling the parallel processing of the price segments by multiple processors.

Reference will now be made in detail to illustrative embodiments of the invention, examples of which are illustrated in the accompanying drawings. Wherever possible, the same reference numbers will be used throughout the drawings to refer to the same or like parts.

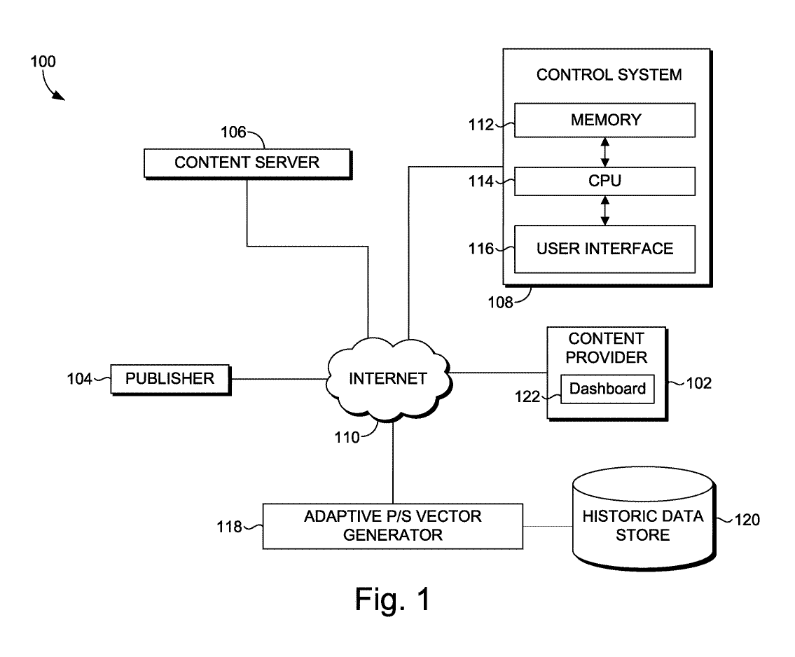

FIG. 1 depicts an illustrative content delivery system 100, in accordance with embodiments of the present disclosure. As shown in FIG. 1, content delivery system 100 may include one or more content providers 102, publishers 104, content servers 106, control systems 108, adaptive price/spend (P/S) vector generators 118 that are in communication with one another through a network, such as the Internet 110. The number and orientation of the computing components in FIG. 1 is provided for purposes of illustration only. Any other number and orientation of components is possible. For example, one or more content providers 102, publishers 104, content servers 106, control systems 108, adaptive P/S vector generators 118, and historic data stores 120 may be combined or co-located and/or communicate directly with one another, instead of over Internet 110. The components of FIG. 1 may include any type or configuration of computers and/or servers, such as, for example, a server cluster, a server farm, load balancing servers, distributed servers, etc. In addition, each component may include one or more processors, memories or other data storage devices (i.e., computer-readable storage media), such as hard drives, NOR or NAND flash memory devices, or Read Only Memory (ROM) devices, etc., communications devices, and/or other types of computing elements.

Content providers 102 represent computing components associated with entities having online content that the entities desire to deliver to online users. In some embodiments, the content with which the content providers 102 are associated includes targeted content. Targeted content can include, for example, marketing content (e.g., banner content, pop-up content, etc.). Content providers 102 may interact with publishers 104, content servers 106, control systems 108, and/or adaptive P/S vector generator 118 through the Internet 110. Thus, content provider 102 may be able to communicate content delivery information, such as content information, targeting information, user information, budget information, bidding information, etc., to other entities in content delivery system 100. Dashboard 122 can be configured to present information concerning content delivery system 100 and, in particular, existing or potential content delivery campaigns and associated target audiences. This information can include, for example, P/S information discussed herein. In embodiments, this P/S information can include a vector representation of a P/S curve for a target audience of a content delivery campaign to aid a user of dashboard 122 in determining aspects of an online content delivery campaign that includes the target audience. Such a vector representation of a P/S curve can be generated, for example, by adaptive P/S vector generator 118 based on previously observed volume information that is correlated with previously observed price information contained in historic data store 120.

Publishers 104 represent computing components associated with entities having inventories of available online content space. For example, publishers 104 may include computing components associated with online media providers, search engines, e-mail programs, web-based applications, or any computing component or program having online user traffic. Publishers 104 may interact with content providers 102, content servers 106, and/or controllers 108 via the Internet 110. Thus, publishers 104 may be able to communicate inventory information, such as site information, demographic information, cost information, etc., to other computing components in system 100.

Content servers 106 may include servers or clusters of servers configured to process content delivery information from content provider 102 and/or inventory information from publishers 104, either directly or indirectly. In certain embodiments, content servers 106 may be remote web servers that receive content information from content provider 102 and serve content to be placed by publishers 104 on websites maintained, controlled, or owned by publishers 104. Content servers 106 may be configured to serve content across various domains of publishers 104, for example, based on content delivery information provided by content providers 102. Content servers 106 may also be configured to serve content based on contextual targeting of web sites, search results, and/or user profile information, all of which can be utilized in determining a target audience for the content. In some embodiments, content servers 106 may be configured to serve content based on control signals generated by control systems 108.

Historic data store 120 can include historic information concerning each impression that is delivered within content delivery system 100, including a price of each impression (e.g., clearing price), additional events that the impression lead to (e.g., click-through, conversion, viewed, etc.), and audience information for the impression (e.g., website, location information, demographic information, etc.).

Adaptive P/S vector generator 118 can utilize the historic information discussed above to generate a vector representation of a price/spend curve of a target event for a target audience. Such a vector representation can include a sequence of prices each price correlated with a low spend estimate and a high spend estimate for the target event at the respective price. In embodiments, the prices included within the sequence of prices can be determined such that prices included within the vector representation are determined based, at least in part, on a difference between the low spend estimate and the high spend estimate for the respective price. The generation of such a vector representation is discussed in greater detail below.

Control system 108 may include computing systems configured to receive information from computing components in system 100, process the information, and generate marketing control signals to be sent to other computing components in system 100, according to the illustrative methods described herein. As discussed in greater detail below, operations performed by campaign control system 108 can, for example, be initialized, re-initialized, or guided utilizing a representation of a P/S curve (e.g., that produced by adaptive P/S vector generator 118). Control systems 108 may include any type or combination of computing systems, such as clustered computing machines and/or servers, including virtual computing machines and/or virtual servers. Control systems 108 may include, for example, implementations of Adlearn Open Platforms (AOP) control systems offered by America Online (AOL) of New York, N.Y. In some embodiments, control systems 108 may include an assembly of hardware, including a memory 112, a central processing unit (“CPU”) 114, and/or a user interface 116. Memory 112 may include any type of RAM or ROM embodied in a physical, computer-readable storage medium, such as magnetic storage including floppy disk, hard disk, or magnetic tape; semiconductor storage such as solid state disk (SSD) or flash memory; optical disc storage; or magneto-optical disc storage. CPU 114 may include one or more processors for processing data according to instructions stored in the memory, for example to perform the methods and processes discussed in detail herein. The functions of the processor may be provided by a single dedicated processor or by a plurality of processors. Moreover, the processor may include, without limitation, digital signal processor (DSP) hardware, or any other hardware capable of executing software. User interface 116 may include any type or combination of input/output devices, such as a display monitor, graphical user interface, touch-screen or pad, keyboard, and/or mouse. In other embodiments, campaign control systems 108 may include virtual representations of hardware operating, for example, on a virtualization server.

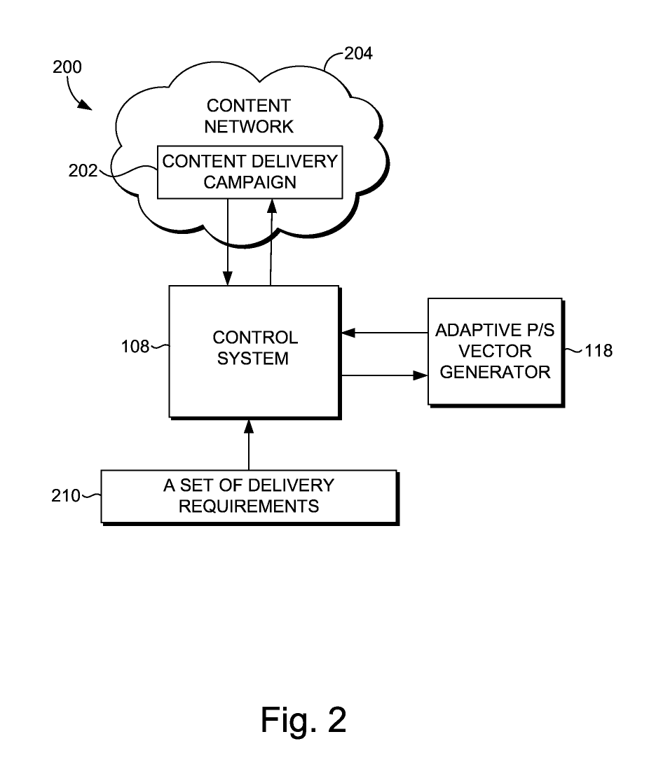

FIG. 2 depicts an illustrative online content delivery environment 200 for controlling an online content delivery campaign 202 operating in an online content network 204. Content network 204 may include a network or collection of one or more content providers 102, one or more publishers 104, content servers 106, control systems 108, adaptive P/S vector generator 118, or other components of system 100. Elements of content network 204 may operate to receive requests for content (e.g., impression request) associated with one or more content space inventories, e.g., from publishers 104 such as websites or other computing components with an inventory of available content space. Content network 204 may also group content requests for various content delivery campaigns, e.g., according to impressions to be “targeted” based on a combination of attributes defined by the content requests. Content network 204 may also accept bids (e.g., from one or more control systems 108) on the content requests and process the bids to serve content (e.g., targeted content) to the content requests.

Any number or type of content delivery campaigns 202 may be operated within content network 204, across various content servers and domains associated with the Internet. Online content delivery environment 200 may be implemented by one or more of the content providers 102, publishers 104, content servers 106, and/or control systems 108 described in FIG. 1. For example, online content delivery environment 200 may represent the interaction of one or more control systems 108 with other computing components in system 100.

In one embodiment, online content delivery environment 200 may include one or more instances of control system 108. Control system 108 may comprise computers or servers connected to the Internet. Such computers or servers may be configured as described with respect to control system 108, as depicted by FIG. 1, or in any other suitable configuration. Alternatively, control system 108 may be implemented by software modules executed by CPUs 114 of control system 108. Control system 108 may be embodied entirely in hardware, entirely in software, or in any combination of hardware and software implemented across any number of computing devices.

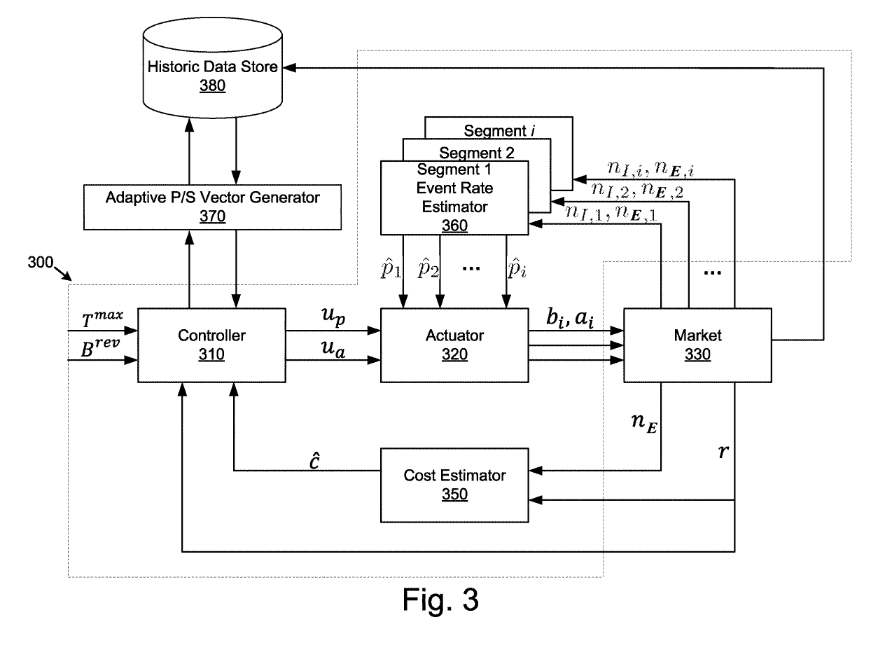

Control system 108 may be provided with a set of delivery requirements 210, which may be adjustable design parameters set by a user. For instance, the set of delivery requirements may include cost requirements (e.g., the maximum cost discussed in reference to FIG. 3), pacing requirements (e.g., daily budget goals, daily content delivery goals), targeting requirements (e.g., based on a demographic analysis) for a target audience, and/or spread requirements (e.g. to control content delivery across inventory units/cells/segments, and/or user targets, etc.). The set of delivery requirements 210 may be implemented by control system 108.

In addition to the set of delivery requirements, control system 108 can also be provided with P/S information. This P/S information can be provided in the form of a vector representation of a P/S curve generated by adaptive P/S vector generator 118. This vector representation of a P/S curve can be provided in response to a request submitted by control system 108 to adaptive P/S vector generator 118. Such a request can identify a target event and a target audience to utilize in generating the vector representation of the P/S curve. Adaptive P/S vector generator 118 can utilize historic information, such as that discussed above, to generate a vector representation of a P/S curve of the target event for the target audience. As mentioned previously, such a vector representation can include a sequence of prices each price correlated with a low spend estimate and a high spend estimate for the target event at the respective price. In embodiments, the prices included within the sequence of prices can be determined such that prices included within the vector representation are determined based, at least in part, on a difference between the low spend estimate and the high spend estimate for the respective price. The generation of such a vector representation is discussed in greater detail below.

FIG. 3 depicts a block diagram of a portion of an illustrative control system 300 for controlling online content delivery campaigns communicatively coupled with an adaptive P/S vector generator 370, in accordance with various embodiments of the present disclosure. Control system 300 may generally be configured to utilize data previously observed in market 330. This data can be utilized to control subsequent bids placed in market 330 to facilitate, for example, obtaining the desired pacing, and/or delivery, at or below a cost limit set by the content provider. As depicted, control system 300 includes a controller 310 (e.g., control system 108 of FIG. 2), an actuator 320, a market 330, a cost estimator 350, and a plurality of segment performance rate estimators 360, an adaptive P/S vector generator 370, and a historic data store 380. Each of these components may be communicatively coupled with one another, for example, as depicted in FIG. 3. This communicative coupling may be, for example, via a bus, network, shared memory, etc., or any combination thereof.

Cost estimator 350 is configured to take as input an observed event volume, n_{E}; and observed revenue, or pacing, r. The observed event volume and the observed revenue can be determined from actual event volume and revenue observed in market 330. The observed event volume and/or the observed revenue may be a moving average calculated over a period of time. This period of time can be any duration of time that may be selected based upon certain campaign characteristics. For example, a shorter period of time can enable quicker reflection of changes in market 330, however the results could be noisier than those of a moving average calculated over a longer period of time. A moving average calculated over a longer period of time, on the other hand, can be less noisy than a moving average calculated over a shorter period of time, but is slow to react to changes in market 330. As a result, the time period for such a moving average may be dependent on the campaign and/or volatility of market 330. The above discussed moving average may be calculated by a moving average filter that could be located in-line between market 330 and cost estimator 350. Discrete observed event volume and observed revenue in market 330 may be monitored, for example, via an event volume sensor and a revenue sensor configured to obtain real-time data about the campaign to which control system 300 is assigned. Cost estimator 350 may produce an estimated cost, ĉ, based, at least in part on, the observed event volume, n_{E}, and the observed revenue, r.

Controller 310 is configured to take as input a max cost reference signal, T^{max}, hereinafter merely referred to as max cost. Max cost may be a user (e.g., content provider) defined maximum cost that the user is willing to pay for an event. As used herein, event refers to any action taken with an instance of content (e.g., impression, click, or conversion). In embodiments, max cost may represent the maximum average cost the user is willing to pay for each event, the maximum discrete cost the user is willing to pay for each event, or any other suitable cost restriction.

Controller 310 is also configured to take as input a desired pacing reference signal, B^{rev}. Desired pacing may be user defined and may also be referred to as a maximum desired revenue or a maximum budget. As used herein, revenue may refer to actual dollars spent or actual events delivered. As such, desired pacing may be expressed as monetary units (e.g., dollars spent) or as a number of events. For example, if a content delivery campaign has a daily budget of $900 and has spent $800 in a given day, observed pacing for the campaign on that given day is $800. Controller 310 is also configured to take as input the observed pacing, r, and the cost estimate, ĉ, which was produced by cost estimator 350.

Controller 310 is configured to determine a price control signal, uₚ. Once control system 300 has been operating for a period of time, the price control signal, uₚ can be calculated by controller 310 based, at least in part, on the max cost and the desired pacing, in addition to observed pacing, r, and the estimated cost, ĉ. However, during the time period when controller 310 first begins operating, there is no observed pacing, r, from market 330 to utilize in determining the price control signal, uₚ. In addition, as mentioned above, cost estimator 350 also utilizes observed pacing, r, to determine the estimated cost, ĉ. As mentioned previously, observed pacing can be based on dollars spent. As such, accurate estimation of anticipated dollars spent at can be important to achieving the goals of the campaign to which controller 310 is assigned. As a result of these considerations, controller 310 may need to rely on historic data from market 330 to initially determine a price signal that is calculated to facilitate obtaining the desired pacing within the limits of max cost and/or inventory available in market 330.

As used herein, historic data, with respect to a marketing campaign, refers to data collected prior to the implementation, or operation, of the marketing campaign. This is as opposed to observed data, which refers to data that is observed while the marketing campaign is operating. This historic data can be acquired by controller 310 submitting a request (e.g. to adaptive P/S vector generator 370 discussed below) to acquire the historic data. Such historic data can be stored in historic data store 380. In embodiments, historic data store 380 can include data collected across any number of content delivery campaigns. This data can include, for example, information on each impression that was delivered within market 330, including a price of each impression (e.g., clearing price), additional events that the impression lead to (e.g., click-through, conversion, viewed, etc.), and audience information for the impression (e.g., website, location information, demographic information, etc.).

In embodiments, the above discussed historic data can take the form of a P/S curve that correlates a prices with a corresponding estimated resulting spend at each price. The estimated spend could be based on volumes of an event that resulted from respective prices within the range of prices. One mechanism for providing such a P/S curve is to equally divide the range of prices into increments (e.g., into $0.01 price increments) and to determine an estimated spend corresponding with each increment. Such a mechanism, however, does not take into account that certain prices segments within the price range yield higher magnitude spend changes than other price segments within the price range, which may yield little to no change in magnitude with respect to spend. As a result, a great deal of processing time can be wasted calculating estimated spend for price increments without regard to the change in volume that the price increment yields. In addition, such a mechanism can provide a large quantity of data. For example, if the price range spans from $0.00 to $20.00, then the resulting data, at $0.01 increments, would include a total of 2,000 points of price data and another 2,000 points of corresponding spend data. As such, in addition to the processing considerations above, a great deal of bandwidth can be taken up in transmitting this quantity of data. Because of these considerations, the above mechanism does not scale well as more and more requests for P/S information are received and processed.

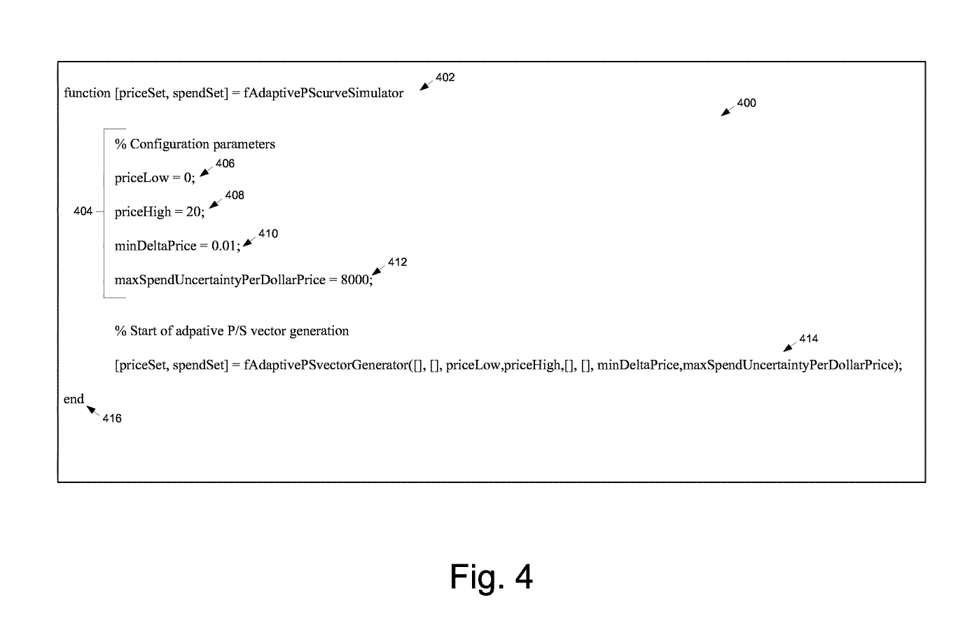

In embodiments of the present disclosure, adaptive P/S vector generator 370 is configured to generate a vector representation of a P/S curve such that price segments that are included within the vector representation are selected based, at least in part, on a difference in magnitude in estimated spend that occurs across the price segment. Furthermore, prices that fall within the price segments need not be analyzed, saving a great deal of computational resources. In addition a great deal of bandwidth savings can also be realized by only transmitting those price segments that are included within the vector representation of the P/S curve. It will also be appreciated that each price segment can be processed independently thereby enabling the parallel processing of the price segments by multiple processors. Example methods for generating such a vector representation are discussed below in reference to FIGS. 4-8.

As mentioned above, controller 310 is configured to determine a price control signal, uₚ, based on the above described input data. Such a price control signal can be determined by any suitable function. In embodiments, such a function may be configured to attempt to facilitate obtaining the desired pacing within the limits of max cost and/or inventory available in market 330. Such functions are known in the art and will not be discussed further herein. In some embodiments, an allocation control signal, uₐ, can also be calculated by controller 310. Such an allocation control signal represents the percentage or ratio (e.g., point value from 0 to 1) of inventory the campaign is willing to purchase at the bid price discussed below.

In some embodiments, controller 310 is configured to periodically update the price control signal, uₚ, as well as allocation control signal, uₐ, if utilized. These periodic updates may take place at predefined time intervals (e.g., every 15 minutes), based on a specific occurrence (e.g., based on a magnitude of change to observed pacing), or any other suitable period. In other embodiments, campaign controller 310 may update the price control signal, uₚ, in real time as the above discussed signals change.

Segment performance rate estimators 360 are configured to take as input an observed impression volume for a segment, n_{I,i}, and an observed event volume for the segment, n_{E,i}. The ‘i’ refers to the segment in which the observed impression volume and the observed event volume were observed. As used herein a segment refers to a defined portion of market 330. Such a segment may be, for example, a website, a group of individuals identified by demographic analysis (e.g., males between the age of 25 and 35 in California), a distinct individual, etc. A segment may also e.g. be referred to in the art, and herein, as a cell or unit. The observed impression volume, n_{I,i}, and the observed event volume, n_{E,i} for each segment can be determined from actual observations in market 330 pertaining to the respective segment. Discrete observed impression volumes for the segments and discrete observed event volumes for the segments may be monitored in market 330, for example, via segment impression sensors (not depicted) and segment event sensors (not depicted), respectively, configured to obtain real-time data about the segment to which these components are assigned. Segment event rate estimator 360 can output a performance prediction, \hat{p}ᵢ, for each segment (‘i’).

Actuator 320 takes the price control signal, uₚ, and allocation control signal, uₐ, as input. In addition, actuator 320 can take the one or more segment performance predictions, \hat{p}ᵢ, as input. Again, the ‘i’ refers to the segment to which the segment performance prediction belongs. Actuator 320 may utilize the combination of the price control signal, uₚ, the allocation signal, uₐ, and the segment performance predictions, \hat{p}ᵢ, to calculate a bid price, bᵢ, and an allocation at that bid price, aᵢ, for the respective segment. In some embodiments, the bid price, bᵢ, is calculated by taking the product of uₚ and \hat{p}ᵢ, for each i. These bids are depicted by the individual arrows flowing from actuator 320 to market 330. In other embodiments, the bid price may be a capped segment bid price calculated, for example, using the equation bᵢ=min(maxCPI, uₚ\hat{p}ᵢ), where maxCPI is max cost per impression, or, as another example, equation bᵢ=min(maxCPIᵢ, uₚ\hat{p}ᵢ), where maxCPIᵢ is max cost per impression for segment i. It will be appreciated by someone of ordinary skill in the art that these examples are merely meant to be illustrative and are not intended to limit the scope of this disclosure. For example, min can be replaced by max and/or the min (max) operation may be conditional based on user, content, or impression specific information. In addition, the capping may apply only for a certain type of user, a certain time of the day, in a certain geographic region, etc.

Market 330 represents a bidding environment in which content providers place requests for content space that is offered by publishers. The above discussed components facilitate a content provider in obtaining the desired pacing within the limits of max cost T^{max} and/or inventory available in market 330.

FIG. 4 depicts illustrative pseudo code for main function 400 that can be utilized for producing a vector representation of a P/S curve, in accordance with various embodiments of the present disclosure. The main function 400 is defined at line 402 where it can be seen that a handle for the main function is defined as “fAdaptivePScurveSimulator,” and that this function returns a vector including a priceSet and a spendSet that are determined within the function.

Code section 404 defines configuration parameters for determining the vector representation of the P/S curve. It will be appreciated that the values for these configuration parameters are merely meant to be illustrative of possible values. The values of these configuration parameters can vary depending on any number of considerations. As a result, the depicted values should not be taken as limiting of this disclosure. The first configuration parameter, “priceLow,” depicted in line 406, represents a minimum price value desired for the vector representation of the P/S curve. The second configuration parameter, “priceHigh,” depicted in line 408, represents a maximum price value desired for the vector representation of the P/S curve. In a specific embodiment, priceLow and priceHigh can be selected to attempt to ensure a full range of the representation of the P/S curve. For example, priceLow can be selected to be equal to, or below, a price at which no spend occurs (i.e., no inventory would be awarded below priceLow), and priceHigh can be selected to be equal to, or above, a highest anticipated price above which no additional spend occurs (i.e., the inventory is exhausted at, or above, priceHigh).

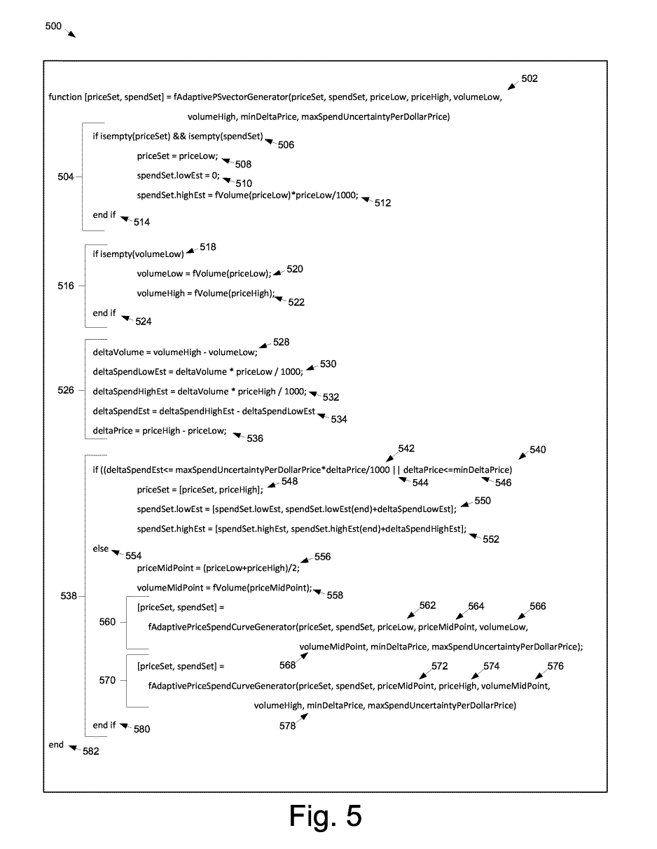

The third configuration parameter, “minDeltaPrice,” depicted in line 410, represents a minimum desired difference in price to be included with a price segment of the vector representation of the P/S curve. The depicted minDeltaPrice is ‘0.01.’ As such, the minimum price segment within the representation of the P/S curve produced by main function 400 would be $0.01. The fourth configuration parameter, “maxSpendUncertaintyPerDollarPrice,” depicted in line 412, is a spend uncertainty threshold that represents a maximum relative difference in spend that is desired within a price segment of the vector representation of the P/S curve. As depicted, the maxSpendUncertaintyPerDollar is 8000 which indicates the maximum difference in Spend across a price segment is 8000. As will be seen in the discussion of FIG. 5, the third and fourth configuration parameters can act as termination criteria for recursively partitioning P/S information into price segments to produce a representation of a P/S curve. It will be appreciated that the configuration parameters discussed above can be user defined parameters (e.g., through user input), pre-defined parameters (as depicted), dynamically learned parameters (e.g., via machine learning algorithms), programmatically defined parameters, or parameters defined in any number of other ways. In addition, it will be appreciated that the values utilized in defining the configuration parameters are merely meant to be illustrative in nature and should not be treated as limiting of this disclosure.

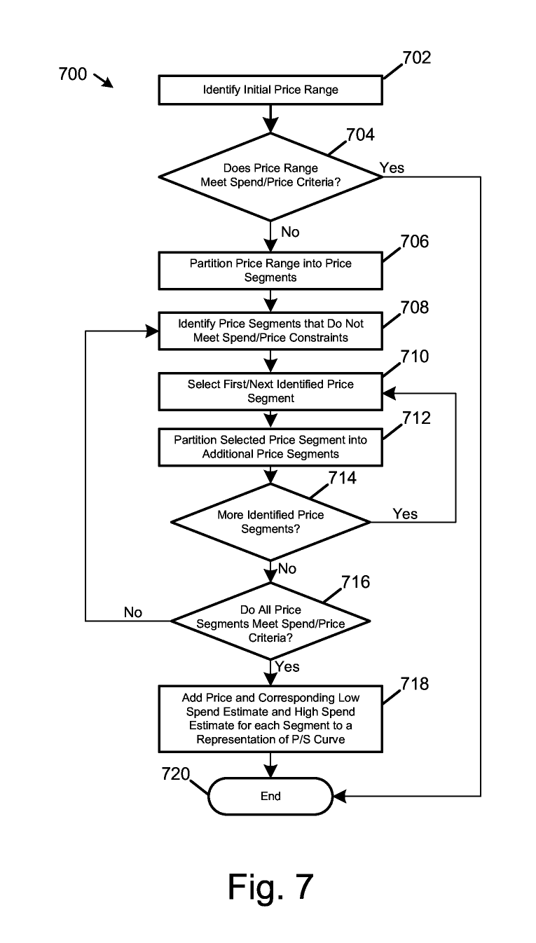

At line 414, the function “fAdaptivePSvectorGenerator” is invoked. As can be seen, the configuration parameters discussed above in reference to code section 404 are passed as input to fAdaptivePSvectorGenerator, along with empty sets/arguments, denoted as ‘[ ],’ which will be discussed in greater detail in reference to FIG. 5. The function fAdaptivePSvectorGenerator can be configured to partition the price range from priceLow to priceHigh into price segments based on the configuration parameters minDeltaPrice and maxSpendUncertaintyPerDollar. In embodiments, fAdaptivePSvectorGenerator can accomplish this by iteratively, or recursively, partitioning the prices between priceLow and priceHigh such that price segments included within priceSet are determined based on a magnitude of difference in estimated spend represented by the price segments. For example, in one embodiment, the difference in spend represented by any price segment may be desired to be limited by a predefined threshold (e.g., maxSpendUncertaintyPerDollar). An example of such a function implemented in a recursive manner is depicted in FIG. 5, discussed below, and an example iterative process flow is depicted by FIG. 7. It will be appreciated that once fAdaptivePSvectorGenerator completes processing, that priceSet will include a selection of prices within the range from priceLow to priceHigh, and spendSet will include estimated spend amounts that correspond with the prices included in priceSet. In embodiments, these estimated spend amounts can be represented as a low estimated spend amount (e.g., spendSet.lowEst) and a high estimated spend amount (e.g., spendSet.highEst). These could be included, for example, as sub-vectors of the spendSet, as depicted in FIGS. 4 and 5.

FIG. 5 depicts pseudo code for an illustrative fAdaptivePSvectorGenerator function 500, hereinafter function 500 for ease of reference. Function 500 can be utilized in producing a representation of a P/S curve, in accordance with various embodiments of the present disclosure. Function 500 is defined at line 502 where it can be seen that function 500 returns a vector including a priceSet and a spendSet that are determined within the function. To accomplish this, function 500 takes, as input parameters, the configuration parameters discussed in reference to code section 404 of FIG. 4. Function 500 also takes, as input, additional parameters represented by priceSet, spendSet, volumeLow, and volumeHigh. Recall that each of these additional parameters were passed as empty sets/arguments in line 414 of FIG. 4.

Moving to code section 504, it will be appreciated that code section 504 represents an ‘if’ block, beginning at line 506, that when satisfied results in the body of the if block, represented by lines 508-512, being executed. If priceSet and spendSet are both empty, then priceSet and spendSet are populated with initial values in code section 504. As can be seen, line 506 includes two combined conditions represented by ‘isempty(priceSet)’ and ‘isempty(spendSet)’ joined by a logical ‘and’ operator, ‘&&.’ The ‘isempty’ function returns true if the variable passed to the isempty function is empty, or has yet to be populated, and false if the variable is not empty, or has been populated. As such, if either of the priceSet or spendSet have been populated, the body of the if statement will not be executed. However, if neither of priceSet nor spendSet have been populated then the processing proceeds to line 508, where priceLow is initially added to priceSet. Returning to FIG. 4, recall that priceLow was initialized to ‘0’ at line 406, as such, priceSet will be initialized to include 0 as the first value at line 508 in this example.

A current price segment will be referred to in describing the processing of function 500. It will be appreciated that current price segment in this context refers to a price segment currently being processed by function 500. As such, the current price segment is defined by priceLow and priceHigh. It will also be appreciated that the current price segment varies depending upon the stage of processing, as discussed further in reference to the recursive function calls contained in lines 560 and 570.

Lines 510 and 512 initialize the spendSet.lowEst and the spendSet.highEst for the current price segment. It will be appreciated that, in this context, spendSet.lowEst represents a lower bound of the spend at priceLow. As such, spendSet.lowEst is initialized to 0 at line 510.

At line 512 spendSet.highEst is initialized for the current price segment. As depicted, spendSet.highEst represents an upper bound of spend at priceLow. To determine this, the estimated volume awarded at priceLow would need to be determined. As can be seen, the estimated volume at priceLow is determined utilizing the function ‘fVolume.’ The depicted fVolume function is configured to return a cumulative count of a target event, also referred to herein as a volume of the event, for a target audience that occurs at or below a price parameter that is passed to the fVolume function. In embodiments, the fVolume function can also include parameters for the target audience and target event that could be determined based on a request for a representation of a P/S curve. Such a target event can be, for example, impressions, clicks, conversions, views, etc. Such a target audience can include target demographic information, target websites, or any other suitable information for defining a target audience. As can be seen, the fVolume function in line 512 is utilized to determine an estimated count of events that could occur at priceLow, or ‘0’ in this example. Such an estimated count could be arrived at by fVolume utilizing the historic data store discussed elsewhere herein.

Once the estimated volume at priceLow is determined, the spendSet.highEst can be calculated by multiplying the estimated volume of the target event by the price for each event. As depicted here, the priceLow reflects the price per 1000 of the target events and thus priceLow is divided by 1000 at line 512 to produce a price per event. This price per event is then multiplied by the estimated volume of the target event at priceLow to produce the high spend estimate for priceLow. This high spend estimate is then appended to spendSet.highEst. At line 514, the if block represented in code section 504 is ended. It will be appreciated that, at least in this example, the above discussed calculations result in both spendSet.lowEst and spendSet.HighEst being initially populated with zeros.

Moving to code section 516, it will be appreciated that code section 516 also represents an ‘if’ block, beginning at line 518, that when satisfied results in the body of the if block, represented by lines 520-522, being executed. If volumeLow is empty, then volumeLow and volumeHigh are populated with initial values in code section 516. As can be seen, line 518 includes a single condition represented by ‘isempty(volumeLow).’ The ‘isempty’ function is discussed in greater detail above in reference to code section 504. If volumeLow has been populated, the body of the if statement will not be executed. However, if volumeLow has not been populated then the processing proceeds to lines 520 and 522 where volumeLow and volumeHigh are initialized. Recall that volumeLow is passed as an empty variable at line 414 of FIG. 4. As such, the function call included in line 414 of FIG. 4 would result in the body of the if block represented in code section 516 being executed. As can be seen, volumeLow is initialized based on the estimated volume that would be awarded at or below priceLow of the current price segment. Processing would then proceed to line 522 where volumeHigh is initialized based on the estimated volume that would be awarded at or below priceHigh of the current price segment. At line 524, the if block represented in code section 516 is ended.

In code section 526 values for various variables are determined. It will be appreciated that, if priceSet, spendSet, and volumeLow are not empty, then processing will pass directly to code section 526. As can be seen at line 528, a value for variable deltaVolumeLow is assigned that corresponds to the difference between volumeHigh and volumeLow for the current price segment. This is accomplished utilizing the fVolume function discussed above in reference to FIG. 4. As such, deltaVolume reflects the magnitude difference in volume for the current price segment. At line 530, a value for deltaSpendLowEst is assigned by taking deltaVolume multiplied by the price per event at priceLow for the current price segment. As discussed above, priceLow, at least in this example, reflects the price per 1000 events and is, therefore, divided by 1000 to arrive at the price per event of priceLow. At line 532, a value for deltaSpendHighEst is assigned by taking deltaVolume multiplied by the price per event at priceHigh for the current price segment. As with priceLow, priceHigh in this example reflects the price per 1000 events and is, therefore, divided by 1000 to arrive at the price per event at priceHigh. At line 534, a value for deltaSpendEst is assigned by taking the difference between deltaSpendHighEst and deltaSpendLowEst. As such deltaSpendEst reflects the magnitude of the spend uncertainty difference across the current price segment. Finally, at line 536, a value for deltaPrice is assigned by taking the difference between priceHigh and priceLow. As such deltaPrice reflects the magnitude of the price difference across the current price segment.

Moving to code section 538, it will be appreciated that code section 538 represents an if/else block, beginning at line 540. If the conditions defined at line 540 are satisfied then the body of the ‘if’ block, represented by lines 548-552, is executed. If, however, the conditions at line 540 are not satisfied, then the body of the else block, represented by lines 556, 558, 560, and 570 are executed.

As can be seen, line 540 includes two alternative conditions represented by 542 and 546 joined by a logical ‘or’ operator 544. As such, if either of conditions 542 or 546 is met, processing would proceed to line 548. It will be appreciated that the depicted conditions are merely meant to be illustrative and that additional or fewer conditions and/or criteria for each condition can be utilized without departing from the scope of this disclosure. At line 548 priceHigh of the current price segment is added to priceSet. At line 550, deltaSpendLowEst is summed with the last element of the spendSet.lowEst vector and the resulting value is appended to the end of spendSet.lowEst. At line 552, deltaSpendHighEst is summed with the last element of the spendSet.highEst vector and the resulting value is appended to the end of spendSet.highEst. As such, once a price segment that satisfies the termination criteria (e.g., 542 or 546 in this example) is encountered, the priceHigh of the current price segment becomes the vector value for the price segment and the spend estimate for priceLow and the spend estimate for priceHigh of that price segment become spendSet.lowEst and spendSet.highEst, respectively.

If neither of conditions 542 or 546 are met then the current price segment does not satisfy the termination criteria and processing can proceed to line 556. At line 556 a variable ‘priceMidPoint’ is set to the midpoint between priceLow and priceHigh. For example, when utilizing the initial configuration parameters for priceLow, 0, and priceHigh, 20, discussed above in reference to FIG. 4, the first priceMidPoint would be 10. At line 558, a variable ‘volumeMidPoint’ is initialized, utilizing the fVolume function, to a volume that corresponds with the priceMidPoint. It will be appreciated that utilizing the midpoint between priceLow and priceHigh is merely meant to be illustrative in nature. Any other suitable partitioning point(s) could be utilized without departing from the scope of this disclosure (e.g., asymmetric binary partition. In addition, in some embodiments, multiple partition points could be selected (e.g., if the deltaSpendEst is very large).

At line 560, function 500 is recursively called where the priceLow is maintained at priceLow, as indicated by 562, however as the calculated priceMidPoint is now passed as the priceHigh argument, as indicated by 564. As such, the current price segment is divided into a first price segment from priceLow to priceMidPoint, and this first segment is passed back into function 500 to have the above described analysis performed again.

Similar to line 560, at line 570, function 500 is again recursively called. In this instance, however, priceMidPoint is now passed as the priceLow argument, as indicated by 572, and priceHigh is maintained as priceHigh, as indicated by 574. As such, the current price segment is divided into a second price segment from priceMidPoint to priceHigh, and this second segment is passed back into function 500 to have the above described analysis performed again.

It will be appreciated that the recursive processing will continue to partition the price range initially passed into function 500 by main function 400 of FIG. 4 until one of conditions 542 or 546 evaluate to true. It will also be appreciated that, for each recursive call another member would be added to priceSet, spendSet.lowEst, and spendSet.highEst by lines 548-552.

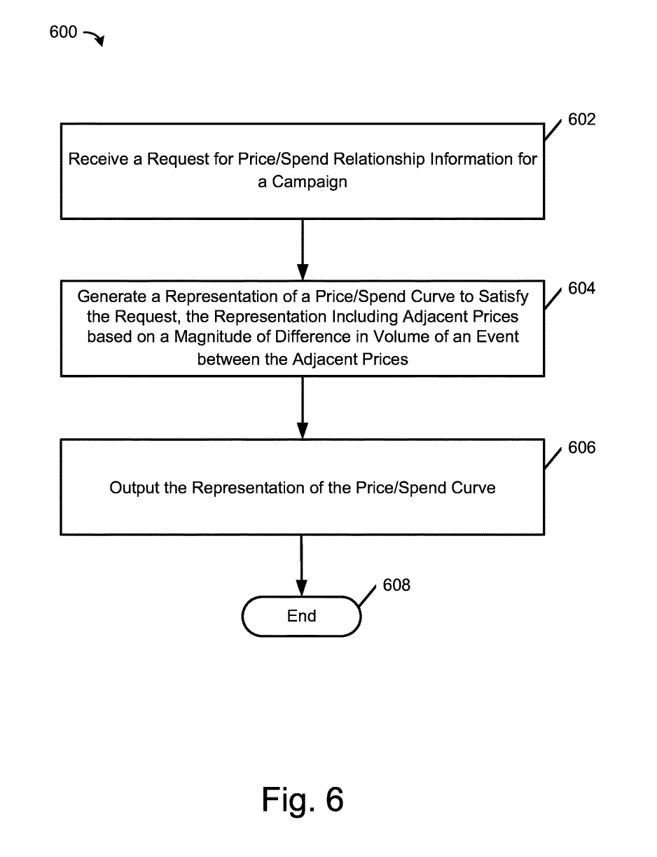

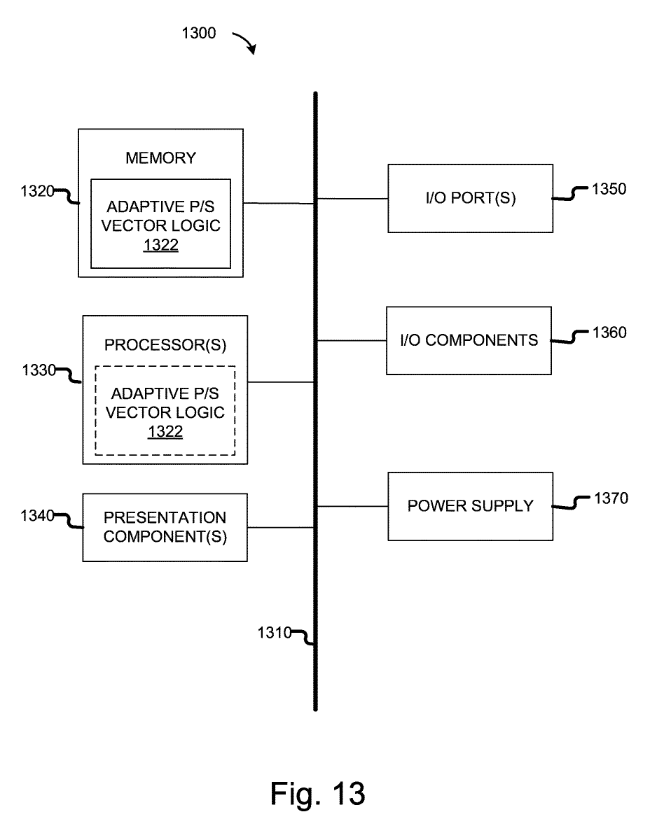

FIG. 6 depicts an illustrative process flow 600 for processing a request for a vector representation of a P/S curve, in accordance with various embodiments of the present disclosure. Process 600 may be performed by processing logic that comprises hardware (e.g., circuitry, dedicated logic, programmable logic, microcode, etc.), software (e.g., instructions run on a processing device to perform hardware simulation), or any combination thereof. As such, process 600 may be performed by a computing device, e.g., computing device 1300 of FIG. 13, to implement one or more embodiments of the present disclosure. It will be appreciated that process 600 can have fewer or additional operations, or perform some of the operations in different orders without departing from the scope of this disclosure.

In various embodiments, the process begins at block 602, where a request for price/spend relationship information is received for a content delivery campaign. This request can be received, for example, from a campaign control system (such as those discussed herein) or from a dashboard (e.g., dashboard 122 of FIG. 1). Such a request can include an identifier for a target event (e.g., impression, view, click, conversion, etc.) and a target audience (e.g., target demographic information, target websites, frequency cap information defining a maximum frequency for which a specific user is to be served targeted content within a specified time interval, etc.).

At block 604, a representation of a P/S curve of the target event for the target audience can be generated. The representation of the P/S curve can include price segments where each price segment included within the representation is based, at least in part, on a magnitude of difference in estimated spend within the price segment. In some embodiments, the representation of the P/S curve can be generated recursively (as discussed in reference to FIG. 5, above, or iteratively as discussed in reference to FIG. 7, below).

At block 606, the representation of the P/S curve can be output to the requestor. As mentioned above, such a requestor can include a campaign control system. The representation of the P/S curve can enable the campaign control system to calculate an initial bid, utilizing the representation of the P/S curve, to achieve a desired pacing. In addition, such a requestor can include a dashboard being utilized by a marketer. The representation of the P/S curve can aid a user of the dashboard in determining aspects of an online marketing campaign that includes the target audience. For example, if the user is wishing to target an audience including only males in California at a selected max cost per event, the representation of the P/S curve can help the user determine if a desired pacing can be achieved within the constraints of the selected max cost per event. If the representation of the P/S curve indicates that the desired pacing cannot be achieved for the target audience within the max cost per event constraints, then the user can decide to adjust the target audience (e.g., include Arizona as well as California), adjust a max cost per event constraint (e.g., increase the max cost per event if the inventory is not exhausted to try to gain additional inventory), or reduce the desired pacing.

It will also be appreciated that such a representation of a P/S curve can also be utilized to troubleshoot a campaign that is not performing as intended. In such an embodiment, an operator of the campaign control system can request a representation of a P/S curve to be utilized to determine if the performance is related to a abnormalities in the expected P/S relationship.

FIG. 7 depicts an illustrative process flow 700 for generating an adaptive representation of a P/S curve, in accordance with various embodiments of the present disclosure. Process 700 may be performed, for example, by adaptive P/S vector generator 118 of FIGS. 1 & 2 or adaptive P/S vector generator 370 of FIG. 3. In various embodiments, process 700 may be performed in reference to block 604 of FIG. 6.

Process flow 700 may begin at block 702, where an initial price range for the representation of the P/S curve is determined. This may be accomplished through input by a user defining a specific range, utilizing a default range, or dynamically searching historic data to identify an appropriate range. It will be appreciated that, in some embodiments, the price range may be selected such that the lowest price of the price range is below any awarded event volume for a target audience and the highest price of the price range is above any awarded event volume for the target audience.

At block 704, a determination is made as to whether the price range meets either a spend uncertainty threshold or minimum price range constraint. The minimum price range constraint could define a minimum price range below which no further division is desired (e.g., minDeltaPrice of discussed in reference to FIGS. 4 and 5). If the price range is equal to or less than the minimum price range constraint, then the determination at block 704 is affirmative (i.e., yes) and processing can proceed to block 720 where processing ends. If the price range is not equal to or less than the minimum price range constraint, then the determination at block 704 may be negative based on whether the price range satisfies the spend uncertainty constraint.

In embodiments, the spend uncertainty threshold could be represented as a desired maximum spend uncertainty (e.g., maxSpendUncertaintyPerDollarPrice discussed in reference to FIGS. 4 and 5) across the price range. Such a maximum spend uncertainty could be defined, for example, by a user. The determination of whether the spend uncertainty constraint could be based on whether the spend uncertainty across the price range, or price segment, is less than or equal to the maximum spend uncertainty. As such, to determine the spend uncertainty a low spend estimate for a lowest price within the price range can be determined and a high spend estimate for a highest price within the price range can be determined. The low spend estimate could be determined based on an estimated difference in volume of a target event that occurs across the price range multiplied by the lowest cost of each target event. The high spend estimate could be determined based on the estimated difference in volume of the target event multiplied by the highest cost of each target event. The difference between this low spend estimate and high spend estimate would represent the spend uncertainty for the price range.

If either the spend uncertainty is smaller than the desired maximum spend uncertainty or the price constraint discussed above is met, then the determination at block 704 is in the affirmative and processing can proceed to block 720 where the processing ends. If, however, the spend uncertainty is larger than the desired maximum spend uncertainty and the price constraint discussed above is not met, then the determination at block 704 is in the negative and processing proceeds to block 706. Because the satisfaction of either the maximum spend uncertainty criteria or the minimum price criteria acts to terminate process flow 700, these criteria can be considered termination criteria. It will be appreciated that additional, or alternative, termination criteria could also be included without departing from the scope of this disclosure.

At block 706 the price range is partitioned into price segments. In some embodiments, the price range is partitioned based on a mid-point of the price range, such that the price range is divided into two substantially equal price segments. In other embodiments, the price range may be divided in another manner.

At block 708 price segments that do not meet the termination criteria mentioned above are identified. Such identification could be accomplished, for example, utilizing similar logic to that depicted in line 540 of FIG. 5, although it will be appreciated that variations on such logic are expressly contemplated by this disclosure. At block 710 a first, or next, identified price segment is selected. At block 712, the selected price segment is further partitioned into additional price segments. Such partitioning could be accomplished in a similar manner to that described above in reference to block 706.

At block 714, a determination is made as to whether there are any more identified price segments. If there are more identified price segments, then the processing proceeds back to block 710, where the next identified price segment is selected and the operations of blocks 710 and 712 are repeated. If there are no more identified price segments, then processing proceeds to block 716 where a determination is made as to whether all price segments that resulted from the processing described above meet the termination criteria. If any price segments do not meet the termination criteria, then the processing returns to block 708 where the above described processes are repeated.

If all price segments meet the termination criteria, then processing proceeds to block 718 where a price representing each price segment (e.g., priceHigh of FIG. 5) and associated low spend estimate and high spend estimate for each price segment are added to a representation of a P/S curve. Such a representation may be, for example, a vector. As used in this context, a vector can take any form that is suitable for correlating each price with corresponding low spend estimate and high spend estimate. As such, the vector could be a three dimensional array where one dimension represents price of the respective price segment, a second dimension represents the low spend estimate of the respective price segment, and the third dimension represents the high spend estimate of the respective price segment. In other embodiments, the vector could be three one dimensional arrays having a corresponding number of members. In these embodiments, one array would represent price, the second array would represent the low spend estimate, and the third array would represent the high spend estimate. In such a scenario the price can be correlated to the corresponding spend estimates based on the respective locations within each array. It will be appreciated that, in other embodiments, the cost and corresponding spend estimates for each segment, or partition, could also be added after each of the above partitioning operations (e.g., after 706 and 712). In such an embodiment, there is a possibility that an ordering operation would be needed to get the prices in ascending order to accurately represent the P/S curve. Once block 718 is complete, the processing can proceed to block 720 where the processing can end.

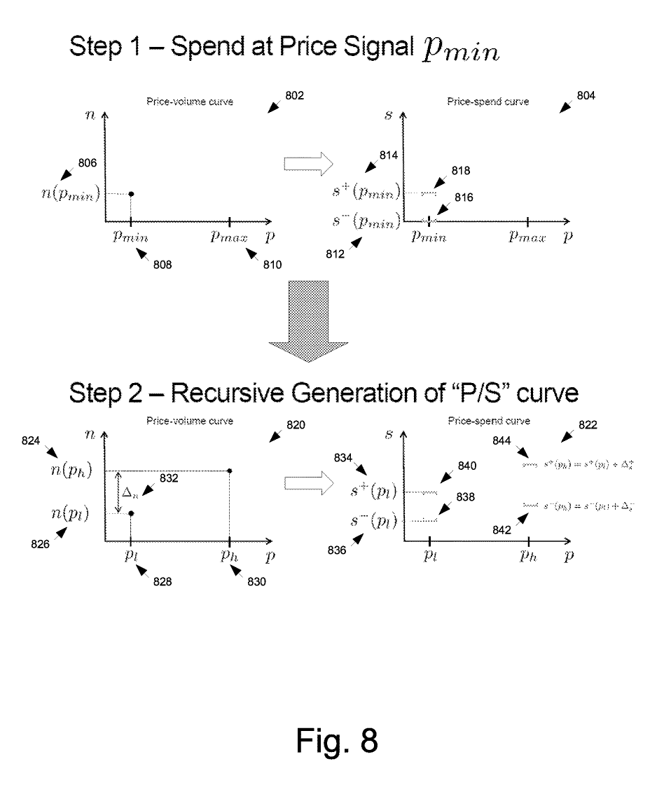

FIG. 8 is a graphical depiction of a partitioning process, with respect to price and spend information, to form a representation of a P/S curve, in accordance with various embodiments of the present disclosure. As can be seen in graph 802, the initial price range, or segment, is depicted by the price range defined by pₘᵢₙ 808 and pₘₐₓ 810. In order to initialize the price/spend curve, the estimated volume of events (e.g., n(pₘᵢₙ) 806) that could be awarded at pₘᵢₙ 808 is determined as depicted in graph 802. Because of the second-price cost model that is often utilized, this volume of events could be awarded at any price point between 0 and pₘᵢₙ 808. As such, the spend uncertainty at pₘᵢₙ can range from a lower bound 816 of n(pₘᵢₙ)*0, represented in graph 804 as s⁻(pₘᵢₙ) 812, to an upper bound 818 of n(pₘᵢₙ)*pₘᵢₙ, represented in graph 804 as s⁺(pₘᵢₙ) 814. Step 2 depicts an example procedure in the recursive generation of a representation of a P/S curve. As can be seen in graph 820, the current price range, or segment, is depicted by the price range defined by price low, pₗ 828, and price high, pₕ 830. It will be appreciated that pₗ 828 and pₕ 830 could correspond with pₘᵢₙ 808 and pₘₐₓ 810, respectively, or could represent an intermediate price segment from any of the recursive operations performed to generate the resulting representation of the P/S curve.

As depicted by graph 820, step 2 begins by determining the estimated volume of events that could be awarded at price low, pₗ 828. This estimated volume of events at price low is represented by n(pₗ) 826. In addition, the estimated volume of events that could be awarded at price high, pₕ 830, is also determined. This estimated volume of events at price high is represented by n(pₕ) 824. From these two data points an estimated difference in volume, Δₙ 832, across current price segment can be determined.

The difference in volume across the current price segment, in conjunction with price low of the current price segment, can be utilized to determine a lower bound on the estimated spend for the current price segment. As such, a lower bound on the current price segment, Δₛ⁻ can be determined by taking the estimated difference in volume, Δₙ 832, of the event multiplied by low price, pₗ 828 (i.e. Δₛ⁻=Δₙpₗ). In a similar manner, the difference in volume across the current price segment, in conjunction with price high of the current price segment, can be utilized to determine an upper bound on the estimated spend for the current price segment. As such, an upper bound on the current price segment, Δₛ⁺ can be determined by taking the estimated difference in volume, Δₙ 832, of the event multiplied by low price, pₕ 830 (i.e. Δₛ⁺=Δₙpₕ).

If the difference between the lower and upper bound on the estimated spend for the current price segment satisfies a desired spend uncertainty threshold, then the data points represented by 844 and 842 can be added to the representation of the P/S curve. If, on the other hand, the difference between the lower and upper bound on the estimated spend for the current price segment is greater than a desired spend uncertainty threshold, then the current price segment can be partitioned into two, or more, price segments and the above process can be repeated for each of those price segments. In some embodiments, the desired spend uncertainty may be represented on a per dollar basis. In such embodiments, the difference between the lower and upper bound would be divided by the difference in price represented by the price segment to yield a spend uncertainty per dollar for the price segment.

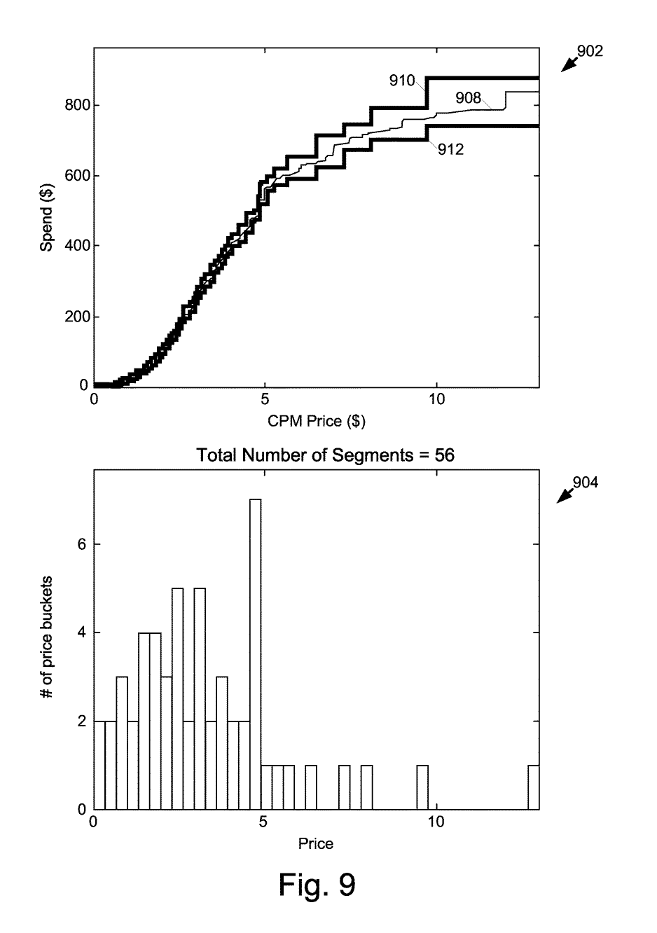

FIGS. 9-12 depicts four example graphs 902, 1002, 1102, and 1202 that depict actual P/S curves and representations of P/S curves, in accordance with various embodiments of the present disclosure. Charts 904, 1004, 1104, and 1204 depict the resulting number of partitions, or segment, utilized to generate the representation of the P/S curves. As depicted in example graph 902, the thinner line 908 represents the actual P/S curve, the upper thicker line 910 represents the high spend estimate for the representation of the P/S curve, and the lower thicker line 912 represents the low spend estimate for the representation of the P/S curve. As can be seen in graph 904, the representation of the P/S curve utilizes a mere 56 partitions, or segments, to generate the representation of the P/S curve. It will also be noted that the partitions are clustered around areas of change to the spend of the P/S curve, rather than evenly distributed across the price range depicted. The depiction in FIG. 9 represents a minDeltaPrice of 0.01 and a maxSpendUncertaintyPerDollarPrice of 8000.

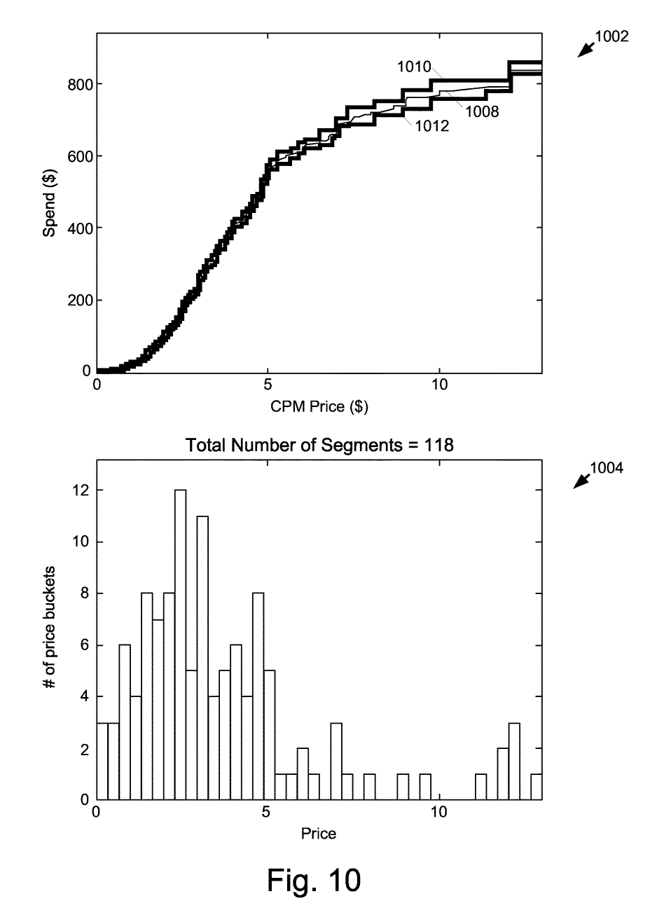

Moving to FIG. 10, as depicted in example graph 1002, the thinner line 1008 represents the actual P/S curve, the upper thicker line 1010 represents the high spend estimate for the representation of the P/S curve, and the lower thicker line 1012 represents the low spend estimate for the representation of the P/S curve. The depiction in FIG. 10 represents the same P/S curve as that depicted in FIG. 9, however, the maxSpendUncertaintyPerDollarPrice has been reduced to 4000. As can be seen in graph 1002, the change to maxSpendUncertaintyPerDollarPrice results in an upper and lower bound that more closely tracks the actual P/S curve as compared with graph 902 of FIG. 9. Even with the more stringent desired maxSpendUncertaintyPerDollarPrice the representation of the P/S curve utilizes a mere 118 partitions, or segments, to generate the representation of the P/S curve. It will also be noted that the partitions are clustered around areas of change to the spend of the P/S curve, rather than evenly distributed across the price range depicted.

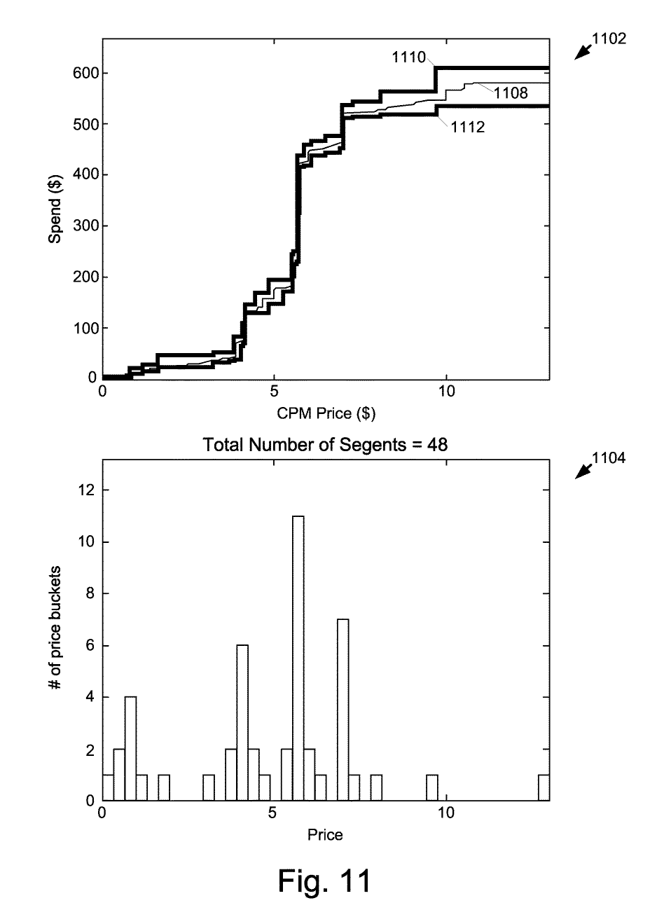

Moving to FIG. 11, as depicted in example graph 1102, the thinner line 1108 represents the actual P/S curve, the upper thicker line 1110 represents the high spend estimate for the representation of the P/S curve, and the lower thicker line 1112 represents the low spend estimate for the representation of the P/S curve. As can be seen in graph 1104, the representation of the P/S curve utilizes a mere 48 partitions, or segments, to generate the representation of the P/S curve. It will also be noted that the partitions are clustered around areas of change to the spend of the P/S curve, rather than evenly distributed across the price range depicted. The depiction in FIG. 11 represents a minDeltaPrice of 0.01 and a maxSpendUncertaintyPerDollarPrice of 8000.

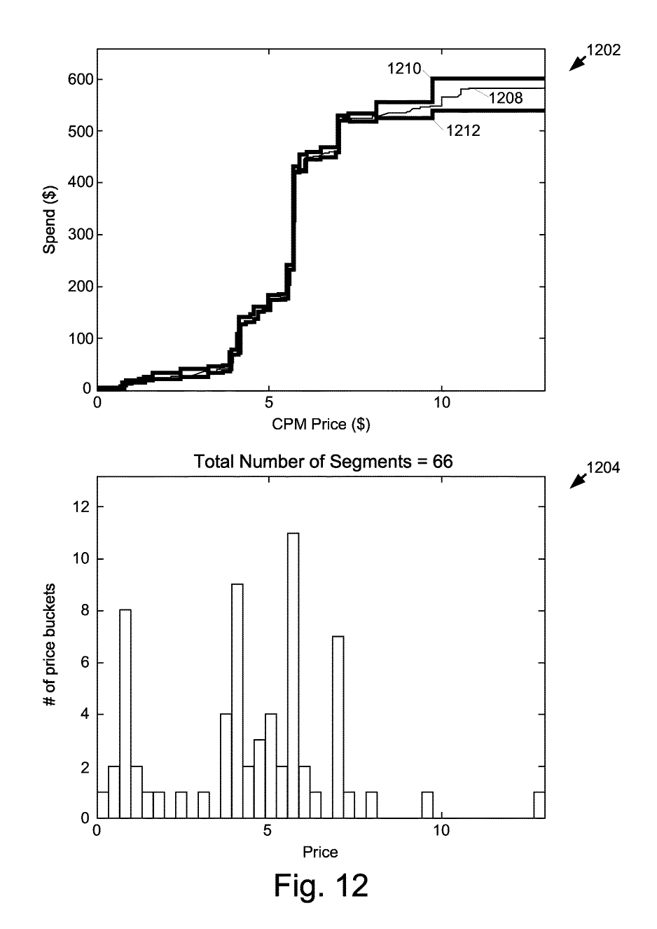

Moving to FIG. 12, as depicted in example graph 1202, the thinner line 1208 represents the actual P/S curve, the upper thicker line 1210 represents the high spend estimate for the representation of the P/S curve, and the lower thicker line 1212 represents the low spend estimate for the representation of the P/S curve. The depiction in FIG. 12 represents the same P/S curve as that depicted in FIG. 11, however, the maxSpendUncertaintyPerDollarPrice has been reduced to 4000. As can be seen in graph 1202, the change to maxSpendUncertaintyPerDollarPrice results in an upper and lower bound that more closely tracks the actual P/S curve as compared with graph 1102 of FIG. 11. Even with the more stringent desired maxSpendUncertaintyPerDollarPrice, the representation of the P/S curve depicted in graph 1204 utilizes a mere 66 partitions, or segments, to generate the representation of the P/S curve. It will also be noted that the partitions are clustered around areas of change to the spend of the P/S curve, rather than evenly distributed across the price range depicted.

It should be recognized that, while each of graphs 902, 1002, 1102, and 1202 are for the same price range, the number of partitions needed to represent the corresponding P/S curves vary from example to example. It will also be appreciated that, utilizing the mechanism described above which would represent the P/S curve utilizing equally spaced partitions across a price range would have represented each of these graphs utilizing the same number of partitions. In the example mentioned above where each graph is represented utilizing $0.01 increments, each of these graphs would have been represented by more than 1,000 partitions. As such, the representation of the P/S curves described herein results in representations of P/S curves that include orders of magnitude fewer points of data, which greatly reduces the processing requirements to produce the representation of the P/S curve as well as the bandwidth to transmit such a representation.

Having described embodiments of the present invention, an example operating environment in which embodiments of the present invention may be implemented is described below in order to provide a general context for various aspects of the present invention. Referring to FIG. 13, an illustrative operating environment, or computing platform, for implementing embodiments of the present invention is shown and designated generally as computing device 1300. Computing device 1300 is but one example of a suitable computing environment and is not intended to suggest any limitation as to the scope of use or functionality of the invention. Neither should the computing device 1300 be interpreted as having any dependency or requirement relating to any one or combination of components illustrated.

The invention may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialized computing devices, etc. The invention may also be practiced in distributed computing environments where tasks are performed by remote-processing devices that are linked through a communications network.

With reference to FIG. 13, computing device 1300 includes a bus 1310 that directly or indirectly couples the following devices: memory 1320, one or more processors 1330, one or more presentation components 1340, input/output (I/O) ports 1350, I/O components 1360, and an illustrative power supply 1370. Bus 1310 represents what may be one or more busses (such as an address bus, data bus, or combination thereof). Although depicted in FIG. 13, for the sake of clarity, as delineated boxes that depict groups of devices without overlap between these groups of devices, in reality this delineation is not so clear cut and a device may well fall within multiple ones of these depicted boxes. For example, one may consider a display to be one of the one or more presentation components 1340 while also being one of the I/O components 1360. As another example, processors have memory integrated therewith in the form of cache; however, there is no overlap between the one or more processors 1330 and the memory 1320. A person of ordinary skill in the art will readily recognize that such is the nature of the art, and it is reiterated that the diagram of FIG. 13 merely depicts an illustrative computing device that can be used in connection with one or more embodiments of the present invention. It should also be noticed that distinction is not made between such categories as “workstation,” “server,” “laptop,” “hand-held device,” etc., as all such devices are contemplated to be within the scope of computing device 1300 of FIG. 13 and any other reference to “computing device,” unless the context clearly indicates otherwise.

Computing device 1300 typically includes a variety of computer-readable media. Computer-readable media can be any available media that can be accessed by computing device 1300 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1300. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1320 includes computer-storage media in the form of volatile and/or nonvolatile memory. The memory may be removable, non-removable, or a combination thereof. Typical hardware devices may include, for example, solid-state memory, hard drives, optical-disc drives, etc. Computing device 1300 includes one or more processors 1330 that read data from various entities such as memory 1320 or I/O components 1360. Presentation component(s) 1340 present data indications to a user or other device. Illustrative presentation components include a display device, speaker, printing component, vibrating component, etc.

In various embodiments, memory 1320 includes, in particular, temporal and/or persistent copies of adaptive P/S vector logic 1322. Adaptive P/S vector logic 1322 includes instructions that, when executed by one or more processors 1330, result in computing device 1300 performing any of the processes and/or actions described above in reference to adaptive P/S vector generator 118 of FIGS. 1 & 2, adaptive P/S vector generator 370 of FIG. 3, process flow 400 of FIG. 4, and/or process flow 500 of FIG. 5.

In some embodiments, one or more processors 1330 may be packaged together with cost estimation logic 1322. In some embodiments, one or more processors 1330 may be packaged together with adaptive P/S vector logic 1322 to form a System in Package (SiP). In some embodiments, one or more processors 1330 can be integrated on the same die with adaptive P/S vector logic 1322. In some embodiments, processor 1330 can be integrated on the same die with adaptive P/S vector logic 1322 to form a System on Chip (SoC).

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method comprising:
receiving, from a control system, a request for price/spend relationship information of a target event for a target audience, the event and the target audience identified by the request;
in response to receiving the request, automatically generating a representation of a price/spend curve of the target event for the target audience, the representation of the price/spend curve including a plurality of price segments, such that price segments included within the representation of the price/spend curve are determined based, at least in part, on a spend uncertainty threshold allowed within each price segment; and
transmitting the representation of the price/spend curve to the control system to enable the control system to determine an initial bid calculated, utilizing the representation of the price spend curve, to achieve a desired pacing.

2. The computer-implemented method of claim 1, wherein generating the representation of the price/spend curve comprises:
partitioning previously collected price data into a plurality of price segments based on a difference in spend uncertainty within each of the price segments.

3. The computer-implemented method of claim 2, further comprising:
determining the difference in spend uncertainty within each of the price segments by:
determining an estimated difference in volume for the target event across the respective price segment;
calculating a low spend estimate for a respective price segment, based on a low price of the respective price segment and the estimated difference in volume, the low price of the respective price segment being the lowest price included within the respective price segment; and
calculating a high spend estimate for the respective price segment, based on a high price of the respective price segment and the estimated difference in volume, the high price of the respective price segment being the highest price included within the respective price segment, wherein the spend uncertainty for the respective price segment is based on a magnitude difference between the low spend estimate and the high spend estimate.

4. The computer-implemented method of claim 2, wherein the representation of the price/spend curve includes price information and spend information for each price segment of the plurality of price segments.

5. The computer-implemented method of claim 3, wherein the price information includes a high price for a respective price segment and the spend information includes a high spend estimate and a low spend estimate for the respective price segment.

6. The computer-implemented method of claim 3, wherein the price information and the spend information are stored in vector form.

7. The computer-implemented method of claim 1, wherein price segments included within the representation of the price/spend curve are also determined based, at least in part, on a minimum desired price difference within the price segment.

8. The computer-implemented method of claim 1, wherein the event is an impression, click, conversion, or a view.

9. One or more computer-readable storage media having instructions embodied thereon which, when executed by one or more processors, cause the one or more processors to:
receive a request for price/spend relationship information of a target event for a target audience, the event and the target audience identified by the request;
in response to the request, automatically generate a representation of a price/spend curve of the target event for the target audience by through partition of previously collected price data into a plurality of price segments based on a difference in spend uncertainty within each of the price segments; and
transmit the representation of the price/spend curve to a control system to enable the control system to determine an initial bid calculated, utilizing the representation of the price spend curve, to achieve a desired pacing.

10. The one or more computer-readable media of claim 9, wherein to partition the previously collected price data into the plurality of price segments includes:
determination of the difference in spend uncertainty within each of the price segments via:
determination of an estimated difference in volume for the target event across the respective price segment;
calculation of a low spend estimate for a respective price segment, based on a low price of the respective price segment and the estimated difference in volume; and
calculation of a high spend estimate for the respective price segment, based on a high price of the respective price segment and the estimated difference in volume, wherein the spend uncertainty for the respective price segment is based on a magnitude difference between the low spend estimate and the high spend estimate.

11. The one or more computer-readable media of claim 9, wherein the partition of previously collected price data into a plurality of price segments is based on a maximum desired spend uncertainty within each of the price segments.

12. The one or more computer-readable media of claim 9, wherein the representation of the price/spend curve includes price information and spend information for each price segment of the plurality of price segments.

13. The one or more computer-readable media of claim 12, wherein the price information includes a high price for a respective price segment and the spend information includes a high spend estimate and a low spend estimate for the respective price segment.

14. The one or more computer-readable media of claim 12, wherein the representation of the price/spend curve is a vector representation of the price spend curve that correlates the price information with the spend information.

15. The one or more computer-readable media of claim 9, wherein the partition of previously collected price data into a plurality of price segments is further based on a minimum desired price difference within each of the price segments.

16. A system, comprising:
one or more processors;
memory, coupled with the one or more processors, having instructions stored thereon, which, when executed by the one or more processors cause the one or more processors to:
receive a request for price/spend information for a target event of a target audience;
partition previously collected price data into a plurality of price segments based on a magnitude of difference in spend represented by each of the price segments;
create a vector representation of a price/spend curve that includes price information and spend information for each of the plurality of price segments;
output the vector representation of the price/spend curve to one of:
a dashboard to aid a user of the dashboard in determining aspects of an content delivery campaign that includes the target audience; or
a control system to enable the control system to determine an initial bid calculated, utilizing the vector representation of the price spend curve, to achieve a desired pacing.

17. The system of claim 16, wherein to partition the previously collected price data into a plurality of price segments based on a magnitude of difference in spend represented by each price segment is further based on a minimum desired price difference within each price segment.

18. The system of claim 16, wherein to partition the previously collected price data into a plurality of price segments is based on a maximum desired spend uncertainty represented by each of the price segments.

19. The system of claim 16, wherein the price information for a respective price segment includes a high price for the respective price segment and the spend information includes a high spend estimate and a low spend estimate for the respective price segment.

20. The system of claim 16, wherein the instructions further cause the one or more processors to:
determine the difference in spend uncertainty within each of the price segments via:
determination of an estimated difference in volume for the target event across the respective price segment;
calculation of a low spend estimate for a respective price segment, based on a low price of the respective price segment and the estimated difference in volume; and
calculation of a high spend estimate for the respective price segment, based on a high price of the respective price segment and the estimated difference in volume, wherein the spend uncertainty for the respective price segment is based on a magnitude difference between the low spend estimate and the high spend estimate.
